(19) United States
(12) Patent Application Publication
(10) Pub. No.: US 2026/0162606 A1
(43) Pub. Date: Jun. 11, 2026

(54) DISPLAY DEVICE

(71) Applicant: Samsung Display Co., Ltd., Yongin-si (KR)

(72) Inventors: Jun Hyun PARK, Yongin-si (KR); Cheol Gon LEE, Yongin-si (KR); Mu Kyung JEON, Yongin-si (KR)

(21) Appl. No.: 19/179,240

(22) Filed: Apr. 15, 2025

(30) Foreign Application Priority Data
Jun. 26, 2024 (KR) 10-2024-0083773
Oct. 14, 2024 (KR) 10-2024-0139105

(51) Int. Cl. G09G 3/3233

(52) U.S. Cl. CPC G09G 3/3233; G09G 2300/0809; G09G 2310/08; G09G 2320/02

(57) ABSTRACT

Provided is a display device. The display device may include a light-emitting element configured to emit light, a first transistor configured to control a driving current through the light-emitting element, a second transistor configured to supply a data voltage to a bias electrode of the first transistor based on a first gate signal, a first capacitor between a gate electrode of the first transistor and a source electrode of the first transistor, and a second capacitor between the bias electrode of the first transistor and the source electrode of the first transistor.

### CROSS-REFERENCE TO RELATED APPLICATION

The present application claims priority to, and the benefit of, Korean Patent Application No. 10-2024-0083773, filed on Jun. 26, 2024, and No. 10-2024-0139105, filed on Oct. 14, 2024, in the Korean Intellectual Property Office, the entire disclosure of which is incorporated herein by reference.

### BACKGROUND

### 1. Field

Aspects of one or more embodiments of the present disclosure relate to a display device.

### 2. Description of the Related Art

With the advance of information-oriented society, more and more demands are placed on display devices for displaying images in various ways. For example, display devices are employed in various electronic devices, such as smartphones, digital cameras, laptop computers, navigation devices, and smart televisions. In the display device, because each of pixels of a display panel includes a light-emitting element capable of emitting light by itself, an image can be displayed without a backlight unit providing light to the display panel.

The display device includes a plurality of pixels, data lines and gate lines connected to the plurality of pixels, a data driver that supplies a data voltage to the data lines, and a gate driver that supplies a gate signal to the gate lines. The data driver and the gate driver may drive a plurality of pixels according to a corresponding frequency.

### SUMMARY

Aspects of some embodiments of the present disclosure include a display device capable of improving the resolution of a product by improving the compensation speed of a gate electrode of a first transistor, and by improving or optimizing the number of transistors in a pixel circuit.

However, aspects of embodiments according to the present disclosure are not restricted to those set forth herein. The above and other aspects of embodiments according to the present disclosure will become more apparent to one of ordinary skill in the art to which the present disclosure pertains by referencing the detailed description of the present disclosure given below.

According to one or more embodiments of the present disclosure, a display device includes a light-emitting element configured to emit light, a first transistor configured to control a driving current through the light-emitting element, a second transistor configured to supply a data voltage to a bias electrode of the first transistor based on a first gate signal, a first capacitor between a gate electrode of the first transistor and a source electrode of the first transistor, and a second capacitor between the bias electrode of the first transistor and the source electrode of the first transistor.

The display device may further include a third transistor configured to electrically connect the gate electrode and the bias electrode of the first transistor, and a fourth transistor configured to supply a reference voltage to the gate electrode of the first transistor.

The display device may further include a third transistor configured to electrically connect the gate electrode and the bias electrode of the first transistor, a fourth transistor configured to supply a driving voltage to the gate electrode of the first transistor, and a fifth transistor configured to supply the driving voltage to a drain electrode of the first transistor.

The display device may further include a fifth transistor configured to supply a driving voltage to the drain electrode of the first transistor, and a sixth transistor configured to electrically connect the source electrode of the first transistor and a first electrode of the light-emitting element.

The display device may further include a seventh transistor configured to initialize the source electrode of the first transistor to an initialization voltage.

The first, second, third, fourth, and seventh transistors may include n-type transistors, wherein the fifth and sixth transistors include p-type transistors.

The seventh transistor may be configured to be turned on based on a third gate signal during a first period, wherein the third and fourth transistors are configured to be turned on based on a second gate signal during a second period after the first period, and wherein the second transistor is configured to be turned on based on the first gate signal during a third period after the second period.

The sixth transistor may be configured to be turned on based on a second emission signal during the first period, during the third period, and during a fourth period after the third period, wherein the fifth transistor is configured to be turned on based on a first emission signal during the second period and during the fourth period.

The sixth transistor may be configured to be turned on before the second transistor is turned on during the third period.

The sixth transistor may be configured to be turned on while the second transistor is turned on, or after the second transistor is turned on.

A gate electrode of the seventh transistor and a gate electrode of the fifth transistor may be connected to a first emission control line to which a first emission signal is applied.

The display device may further include a seventh transistor configured to initialize the first electrode of the light-emitting element to an initialization voltage.

According to one or more embodiments of the present disclosure, a display device includes a light-emitting element configured to emit light, a first transistor configured to control a driving current flowing through the light-emitting element, a second transistor configured to supply a data voltage to a gate electrode of the first transistor based on a first gate signal, a third transistor configured to electrically connect a bias electrode and the gate electrode of the first transistor, a first capacitor between the gate electrode of the first transistor and a source electrode of the first transistor, and a second capacitor between the bias electrode of the first transistor and the source electrode of the first transistor.

The display device may further include a fourth transistor configured to supply a reference voltage to the gate electrode of the first transistor.

The display device may further include a fifth transistor configured to supply a driving voltage to a drain electrode of the first transistor, and a sixth transistor configured to electrically connect the source electrode of the first transistor and a first electrode of the light-emitting element.

The display device may further include a seventh transistor configured to initialize the source electrode of the first transistor to an initialization voltage.

The seventh transistor may be configured to be turned on based on a third gate signal during a first period, wherein the third and fourth transistors are configured to be turned on based on a second gate signal during a second period after the first period, and wherein the second transistor is configured to be turned on based on the first gate signal during a third period after the second period.

The sixth transistor may be configured to be turned on based on a second emission signal during the first period, during the third period, and during a fourth period after the third period, wherein the fifth transistor is configured to be turned on based on a first emission signal during the second period and during the fourth period.

According to one or more embodiments of the present disclosure, a display device includes a light-emitting element configured to emit light, a first transistor configured to control a driving current flowing through the light-emitting element, a second transistor configured to supply a data voltage to a bias electrode of the first transistor based on a first gate signal, a seventh transistor configured to initialize a first electrode of the light-emitting element or a source electrode of the first transistor to an initialization voltage, a first capacitor between a gate electrode of the first transistor and the source electrode of the first transistor, and a second capacitor between the bias electrode of the first transistor and the source electrode of the first transistor.

The display device may further include a third transistor configured to electrically connect the gate electrode and the bias electrode of the first transistor, and a fourth transistor configured to supply a reference voltage to the gate electrode of the first transistor.

According to one or more embodiments of the present disclosure, an electronic device includes a display device configured to provide an image, and a processor configured to provide an image data signal to the display device, wherein the display device includes a light-emitting element configured to emit light, a first transistor configured to control a driving current flowing through the light-emitting element, a second transistor configured to supply a data voltage to a bias electrode of the first transistor based on a first gate signal, a first capacitor between a gate electrode of the first transistor and a source electrode of the first transistor, and a second capacitor between the bias electrode of the first transistor and the source electrode of the first transistor.

According to some embodiments of the present disclosure, a first capacitor is formed between a gate electrode and a source electrode of a first transistor to compensate for a voltage of the gate electrode of the first transistor relatively quickly. Also, a second capacitor is formed between a bias electrode and the source electrode of the first transistor to control the turn-on timing of the first transistor, and to adjust the luminance of a pixel. Therefore, the number of transistors in a pixel circuit may be improved or optimized to reduce the area of the pixel circuit, and to improve the resolution of a product.

### BRIEF DESCRIPTION OF THE DRAWINGS

The above and other aspects of embodiments of the present disclosure will become more apparent by describing aspects of some embodiments thereof with reference to the attached drawings, in which:

FIG. 1 is a perspective view showing a display device according to one or more embodiments;

FIG. 2 is a block diagram illustrating a display device according to one or more embodiments;

FIG. 3 is a cross-sectional view illustrating a display device according to one or more embodiments;

FIG. 4 is a circuit diagram illustrating a pixel of a display device according to one or more embodiments;

FIG. 5 is an example of a waveform diagram of signals supplied to the pixel in the display device according to one or more embodiments;

FIG. 6 illustrates another example of a waveform diagram of signals supplied to a pixel in a display device according to one or more embodiments;

FIG. 7 is a circuit diagram showing a pixel of a display device according to one or more other embodiments;

FIG. 8 is a circuit diagram showing a pixel of a display device according to yet one or more other embodiments;

FIG. 9 is a circuit diagram showing a pixel of a display device according to yet one or more other embodiments; and

FIG. 10 is a circuit diagram showing a pixel of a display device according to yet one or more other embodiments.

FIG. 11 is a block diagram of an electronic device according to one or more embodiments of the present disclosure.

FIG. 12 is a schematic diagram of an electronic device according to various embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5 % of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

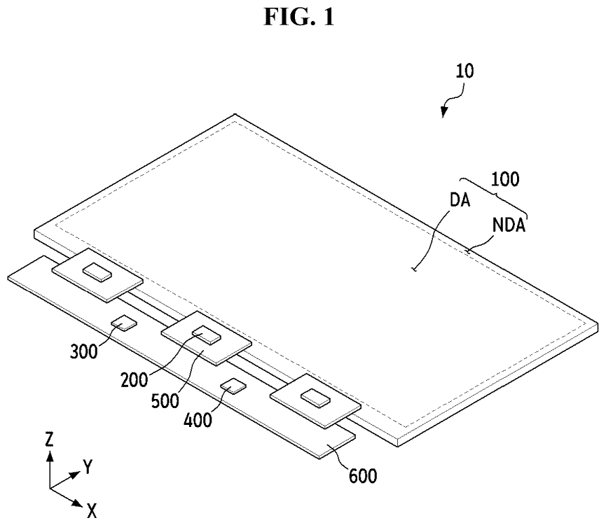

FIG. 1 is a perspective view showing a display device according to one or more embodiments.

Referring to FIG. 1, a display device 10 is a device for displaying a moving image or a still image. The display device 10 may be used as a display screen of various devices, such as a television, a laptop computer, a monitor, a billboard and an Internet-of-Things (IOT) device, as well as portable electronic devices, such as a mobile phone, a smartphone, a tablet personal computer (PC), a smart watch, a watch phone, a mobile communication terminal, an electronic notebook, an electronic book, a portable multimedia player (PMP), a navigation device and an ultra-mobile PC (UMPC).

The display device 10 may include a display panel 100, a display driver 200, a timing controller 300, a power supply (e.g., power supply unit) 400, a data circuit board 500, and a control circuit board 600.

The display panel 100 may have a rectangular plane having a long side in the X-axis direction and a short side in the Y-axis direction intersecting the X-axis direction. The corner where the long side in the X-axis direction and the short side in the Y-axis direction meet may be rounded to have a curvature (e.g., predetermined curvature) or may be right-angled. The planar shape of the display panel 100 is not limited to the rectangular shape, and may be formed in another polygonal shape, a circular shape or an elliptical shape. The display panel 100 may be formed to be flat, but is not limited thereto. For example, the display panel 100 may include a curved portion formed at left and right ends and having a constant curvature or a varying curvature. The display panel 100 may be formed flexibly such that it can be curved, bent, folded, or rolled.

The display panel 100 may include a display area DA displaying an image, and a non-display area NDA located around the display area DA (e.g., in plan view). The display area DA may occupy most of the area of the display panel 100. The display area DA may be located at the center of the display panel 100. The display area DA may include a plurality of pixels displaying an image.

Each of the plurality of pixels may include a light-emitting element that emits light. The light-emitting element may include at least one of an organic light-emitting diode including an organic light-emitting layer, a quantum dot light-emitting diode including a quantum dot light-emitting layer, an inorganic light-emitting diode including an inorganic semiconductor, or a micro light-emitting diode (micro LED), but is not limited thereto.

The non-display area NDA may be located adjacent to the display area DA. The non-display area NDA may be an area outside the display area DA. The non-display area NDA may be located to surround the display area DA (e.g., in plan view). The non-display area NDA may be an edge area of the display panel 100.

The non-display area NDA may include a gate driver, a fan-out line, and a pad portion. The gate driver may supply a gate signal to the gate line of the display area DA. The fan-out line may electrically connect the display driver 200 and the data line of the display area DA. The pad portion may be electrically connected to the data circuit board 500. For example, the pad portion may be located on the edge on one side of the display panel 100, and the gate driver may be located on the edge on the other side adjacent to the edge on one side of the display panel 100, but is not limited thereto.

The display driver 200 may output signals and voltages for driving the display panel 100. The display driver 200 may supply a data voltage to a data line. The display driver 200 may supply a power voltage to the power line and may supply a gate control signal to the gate driver. The display driver 200 may be formed of an integrated circuit (IC) and mounted on a data circuit board 500 by a chip-on-film (COF) method. As another example, the display driver 200 may be mounted on the non-display area NDA of the display panel 100 by a chip-on-glass (COG) method, a chip-on-plastic (COP) method, or an ultrasonic bonding method.

The timing controller 300 may be mounted on the control circuit board 600, and may receive digital video data and a timing synchronization signal supplied from the display driving system or the graphic device through a user connector provided on the control circuit board 600. The timing controller 300 may align digital video data to suit a pixel arrangement structure based on the timing synchronization signal, and may supply the aligned digital video data to the display driver 200. The timing controller 300 may generate the data control signal and the gate control signal based on the timing synchronization signal. The timing controller 300 may control the supply timing of the data voltage of the display driver 200 based on the data control signal, and may control the supply timing of the gate signal of the gate driver based on the gate control signal.

The power supply 400 may be mounted on the control circuit board 600, and may supply a power voltage to the display panel 100 and the display driver 200. For example, the power supply 400 may generate a driving voltage, a common voltage, an initialization voltage, a bias voltage, a gate high voltage, a gate low voltage, or a reference voltage. The power supply 400 may supply a power voltage to drive the plurality of pixels and the display driver 200.

The data circuit board 500 may be located on a pad portion located at the edge on one side of the display panel 100. The data circuit board 500 may be attached to the pad portion using a conductive adhesive member, such as an anisotropic conductive film. The data circuit board 500 may be electrically connected to signal lines of the display panel 100 through an anisotropic conductive film. The display panel 100 may receive the data voltage and the power voltage through the data circuit board 500. For example, the data circuit board 500 may be a flexible printed circuit board, a printed circuit board, or a flexible film, such as a chip on film.

The control circuit board 600 may be attached to the data circuit board 500 using, for example, a low-resistance high-reliability material, such as self-assembly anisotropic conductive paste (SAP) or an anisotropic conductive film. The control circuit board 600 may be electrically connected to the data circuit board 500. The control circuit board 600 may be a flexible printed circuit board or a printed circuit board.

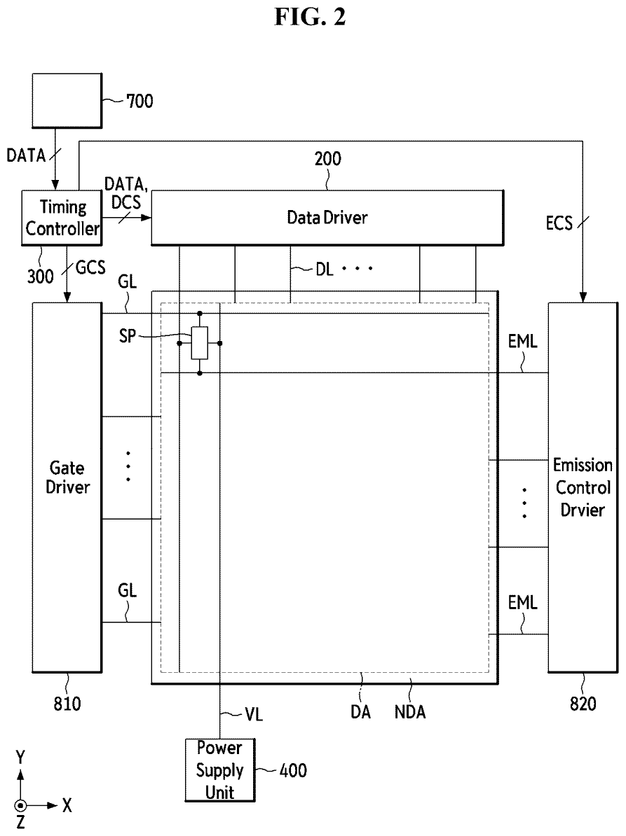

FIG. 2 is a block diagram illustrating a display device according to one or more embodiments.

Referring to FIG. 2, the display panel 100 may include the display area DA and the non-display area NDA.

The display area DA may include a plurality of pixels SP, and a voltage line VL a gate line GL, one or more emission control lines EML, and a data line DL that are connected to the pixels SP.

Each of the pixels SP may be connected to the gate line GL, the data line DL, the emission control line(s) EML, and the voltage line VL. Each of the plurality of pixels SP may include a transistor, a capacitor, and a light-emitting element.

The gate lines GL may extend in the X-axis direction, and may be spaced apart from each other in the Y-axis direction that crosses the X-axis direction. The gate lines GL may sequentially supply gate signals to the plurality of pixels SP.

The emission control lines EML may extend in the X-axis direction, and may be spaced apart from each other in the Y-axis direction. The emission control lines EML may sequentially supply emission signals to the plurality of pixels SP.

The data lines DL may extend in the Y-axis direction, and may be spaced apart from each other in the X-axis direction. The data lines DL may supply the data voltage to the plurality of pixels SP. The data voltage may determine the luminance of each of the pixels SP.

The voltage lines VL may extend in the Y-axis direction, and may be spaced apart from each other in the X-axis direction. The voltage lines VL may supply a power voltage to the plurality of pixels SP. The power voltage may include at least one of a driving voltage, a common voltage, an initialization voltage, a bias voltage, a gate high voltage, a gate low voltage, or a reference voltage. For example, the driving voltage may be a high potential voltage for driving the light-emitting element of the pixel SP, and the common voltage may be a low potential voltage for driving the light-emitting element of the pixel SP.

The display driver 200 may convert digital video data DATA into analog data voltages, and may supply the data voltages to the data line DL through the fan-out line. The gate signal of the gate driver 810 may select a pixel SP to which the data voltage is supplied, and the selected pixel SP may receive the data voltage through the data line DL.

The timing controller 300 may receive the digital video data DATA and timing signals from the graphic device 700. For example, the graphic device 700 may be a graphic card of the display device 10, but is not limited thereto. The timing controller 300 may generate a data control signal DCS based on the timing signal, and may supply the data control signal DCS to the display driver 200, thus controlling the operation timing of the display driver 200. The timing controller 300 may supply the digital video data DATA to the display driver 200. The timing controller 300 may generate a gate control signal GCS based on the timing signal, and may supply the gate control signal GCS to the gate driver 810, thus controlling the operation timing of the gate driver 810. The timing controller 300 may generate an emission control signal ECS based on the timing signal, and may supply the emission control signal ECS to an emission control driver 820, thus controlling the operation timing of the emission control driver 820. The timing controller 300 may vary the driving frequency of the display panel 100 based on the input frequency of the digital video data DATA of the graphic device 700.

The power supply 400 may be located on the data circuit board 500 to supply a power voltage to the display driver 200 and the display panel 100. The power supply 400 may generate a driving voltage to supply the driving voltage to a driving voltage line, and may generate a common voltage to supply the common voltage to a common electrode that is common to the light-emitting elements of the pixel. The power supply 400 may generate an initialization voltage, and may supply it to an initialization voltage line, and may generate a bias voltage, and may supply it to a bias voltage line. The power supply 400 may generate a gate high voltage, and may supply it to a gate high voltage line, may generate a gate low voltage, and may supply it to a gate low voltage line, and may generate a reference voltage, and may supply it to a reference voltage line.

The gate driver 810 may be located at one external side of the display area DA or at one side of the non-display area NDA. The emission control driver 820 may be located at the other external side of the display area DA or at the other side of the non-display area NDA. However, the present disclosure is not limited thereto. As another example, the gate driver 810 and the emission control driver 820 may be located at any one of one side and the other side of the non-display area NDA.

The gate driver 810 may include a plurality of transistors for generating gate signals based on the gate control signal GCS. The emission control driver 820 may include a plurality of transistors for generating emission signals based on the emission control signal ECS. For example, the transistors of the gate driver 810 and the transistors of the emission control driver 820 may be formed in the same layer as the transistors of each pixel SP. The gate driver 810 may supply the gate signals to the gate lines GL, and the emission control driver 820 may supply the emission signals to the emission control lines EML.

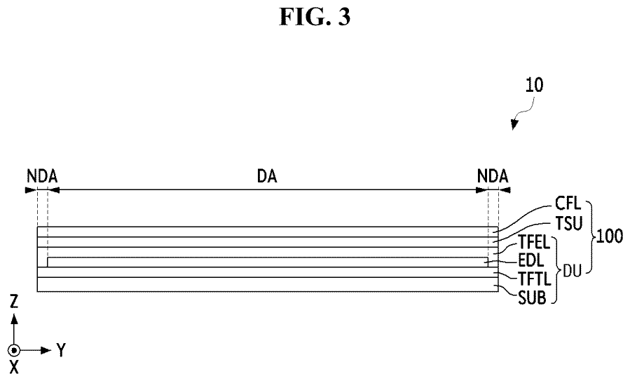

FIG. 3 is a cross-sectional view illustrating a display device according to one or more embodiments.

Referring to FIG. 3, the display panel 100 may include a display (e.g., display unit) DU, a touch sensor (e.g., touch-sensing unit) TSU, and a color filter layer CFL. The display DU may include a substrate SUB, a transistor layer TFTL, a light-emitting element layer EDL, and an encapsulation layer TFEL.

The substrate SUB may be a base substrate or a base member. The substrate SUB may be a flexible substrate which can be bent, folded or rolled. For example, the substrate SUB may include a polymer resin, such as polyimide (PI), but is not limited thereto. For another example, the substrate SUB may include a glass material or a metal material.

The transistor layer TFTL may be located on the substrate SUB. The transistor layer TFTL may include a plurality of transistors constituting a pixel circuit of pixels. The transistor layer TFTL may further include a gate line, a data line, a power line, a gate control line, and a fan-out line connecting the display driver 200 to the data lines. Each of the transistors may include a semiconductor region, a source electrode, a drain electrode, and a gate electrode. For example, when the gate driver is formed on one side of the non-display area NDA of the display panel 100, the gate driver may include transistors.

The transistor layer TFTL may be located in the display area DA and the non-display area NDA. The transistor, the gate line, the data line, and the power line of each of the pixels of the transistor layer TFTL may be located in the display area DA. The gate control line and the fan-out line of the transistor layer TFTL may be located in the non-display area NDA.

The light-emitting element layer EDL may be located on the transistor layer TFTL. The light-emitting element layer EDL may include a light-emitting element in which a pixel electrode, a light-emitting layer, and a common electrode are sequentially stacked to emit light, and a pixel-defining layer for defining pixels. The light-emitting element of the light-emitting element layer EDL may be located in the display area DA.

For example, the light-emitting layer may be an organic light-emitting layer including an organic material. The light-emitting layer may include a hole-transporting layer, an organic light-emitting layer, and an electron-transporting layer. When the pixel electrode receives a voltage (e.g., predetermined voltage) through the transistor of the transistor layer TFTL and the common electrode receives a cathode voltage, holes may move to the organic light-emitting layer through the hole-transporting layer, electrons may move to the organic light-emitting layer through the electron-transporting layer, and the holes and the electrons may combine with each other in the organic light-emitting layer to emit light. For example, the pixel electrode may be an anode electrode, and the common electrode may be a cathode electrode, but the present disclosure is not limited thereto.

For another example, the plurality of light-emitting elements may include a quantum dot light-emitting diode including a quantum dot light-emitting layer, an inorganic light-emitting diode including an inorganic semiconductor, or a micro light-emitting diode.

The encapsulation layer TFEL may cover the top surface and the side surface of the light-emitting element layer EDL, and may protect the light-emitting element layer EDL. The encapsulation layer TFEL may include at least one inorganic film and at least one organic film for encapsulating the light-emitting element layer EDL.

The touch sensor TSU may be located on the encapsulation layer TFEL. The touch sensor TSU may include a plurality of touch electrodes for sensing a user's touch in a capacitive manner, and touch lines connecting the plurality of touch electrodes to a touch driver. For example, the touch sensor TSU may sense the user's touch by using a mutual capacitance method or a self-capacitance method. The plurality of touch electrodes of the touch sensor TSU may be located in a touch sensor area overlapping the display area DA. The touch lines of the touch sensor TSU may be located in a touch peripheral area that overlaps the non-display area NDA.

For another example, the touch sensor TSU may be located on a separate substrate located on the display DU. In this case, the substrate supporting the touch sensor TSU may be a base member that encapsulates the display DU.

The color filter layer CFL may be located on the touch sensor TSU. The color filter layer CFL may include a plurality of color filters respectively corresponding to the plurality of emission areas. Each of the color filters may selectively transmit light of a corresponding wavelength, and may block or absorb light of a different wavelength. The color filter layer CFL may absorb a part of light coming from the outside of the display device 10 to reduce reflected light due to external light. Accordingly, the color filter layer CFL may reduce or prevent color distortion caused by reflection of the external light.

Because the color filter layer CFL is directly located on the touch sensor TSU, the display device 10 may not require a separate substrate for the color filter layer CFL. Therefore, the thickness of the display device 10 may be relatively reduced.

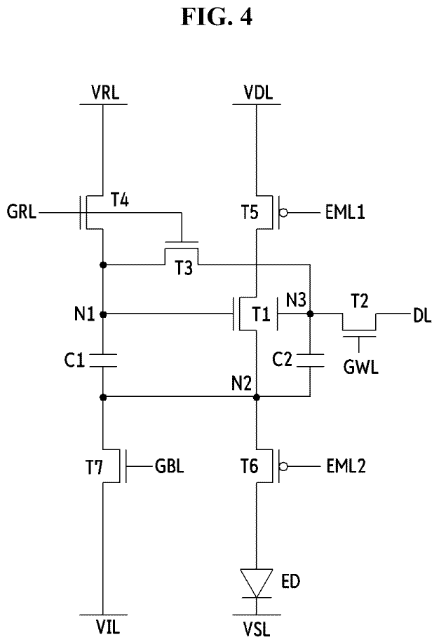

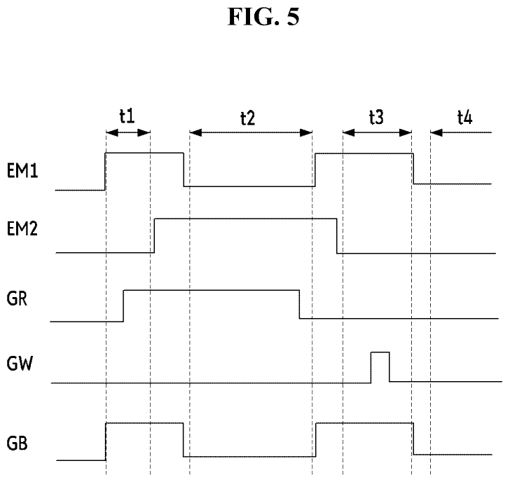

FIG. 4 is a circuit diagram illustrating a pixel of a display device according to one or more embodiments, and FIG. 5 is an example of a waveform diagram of signals supplied to the pixel in the display device according to one or more embodiments.

Referring to FIGS. 4 and 5, the pixel SP may be connected to a first gate line GWL, a second gate line GRL, a third gate line GBL, a first emission control line EML1, a second emission control line EML2, the data line DL, a driving voltage line VDL, a reference voltage line VRL, an initialization voltage line VIL, and a low potential line VSL.

The pixel SP may include a light-emitting element ED and a pixel circuit for driving the light-emitting element ED. The pixel circuit may include the first to seventh transistors T1, T2, T3, T4, T5, T6, and T7 and the first and second capacitors C1 and C2.

The first transistor T1 may control a driving current supplied to the light-emitting element ED. The first transistor T1 may include a gate electrode, a first electrode, a second electrode, and a bias electrode. The gate electrode of the first transistor T1 may be connected to a first node N1, the first electrode thereof may be connected to the second electrode of the fifth transistor T5, the second electrode thereof may be connected to a second node N2, and the bias electrode thereof may be connected to a third node N3. For example, a first electrode of the first transistor T1 may be a drain electrode and the second electrode thereof may be a source electrode, but the present disclosure is not limited thereto.

The first transistor T1 may control a drain-source current (hereinafter, referred to as “driving current”) based on a data voltage applied to the bias electrode. The first capacitor C1 may be connected between the gate electrode and the source electrode of the first transistor T1 to maintain a potential difference between the gate electrode and the source electrode of the first transistor T1. The second capacitor C2 may be connected between the bias electrode and the source electrode of the first transistor T1 to maintain a potential difference between the bias electrode and the source electrode of the first transistor T1. The driving current flowing through the channel of the first transistor T1 may be proportional to the square of a difference between a threshold voltage Vth and a bias-source voltage between the bias electrode and the source electrode of the first transistor T1 (e.g., Ids=k×(Vbs−Vth)²). Here, k is a proportional coefficient determined by the structure and physical characteristics of the first transistor T1, Vbs is a bias-source voltage of the first transistor T1, and Vth is a threshold voltage of the first transistor T1. The bias-source voltage of the first transistor T1 may correspond to a voltage across the second capacitor C2.

The light-emitting element ED may emit light by receiving the driving current. The emission amount or the luminance of the light-emitting element ED may be proportional to the magnitude of the driving current. The light-emitting element ED may include a first electrode, a second electrode, and a light-emitting layer located between the first electrode and the second electrode. The first electrode of the light-emitting element ED may be connected to the second electrode of the sixth transistor T6. The second electrode of the light-emitting element ED may be electrically connected to the low potential line VSL, and may receive a low potential voltage from the low potential line VSL. For example, the first electrode of the light-emitting element ED may be an anode electrode or a pixel electrode, and the second electrode thereof may be a cathode electrode or a common electrode, but the present disclosure is not limited thereto.

The second transistor T2 may be turned on by a first gate signal GW of the first gate line GWL to electrically connect the data line DL with a third node N3 that is the bias electrode of the first transistor T1. The second transistor T2 may be turned on based on the first gate signal GW to supply the data voltage to the third node N3. The gate electrode of the second transistor T2 may be connected to the first gate line GWL, the first electrode thereof may be connected to the data line DL, and the second electrode thereof may be connected to the third node N3. The second electrode of the second transistor T2 may be electrically connected to the bias electrode of the first transistor T1, to the second electrode of the third transistor T3, and to the first electrode of the second capacitor C2 through the third node N3. For example, a first electrode of the second transistor T2 may be a drain electrode, and the second electrode thereof may be a source electrode, but the present disclosure is not limited thereto.

The third transistor T3 may be turned on by a second gate signal GR of the second gate line GRL to electrically connect the first node N1, which is the gate electrode of the first transistor T1, to the third node N3, which is the bias electrode of the first transistor T1. The gate electrode of the third transistor T3 may be connected to the second gate line GRL, the first electrode thereof may be connected to the first node N1, and the second electrode thereof may be connected to the third node N3. The first electrode of the third transistor T3 may be electrically connected to the gate electrode of the first transistor T1, the second electrode of the fourth transistor T4, and the first electrode of the first capacitor C1 through the first node N1. The second electrode of the third transistor T3 may be electrically connected to the bias electrode of the first transistor T1, to the second electrode of the second transistor T2, and to the first electrode of the second capacitor C2 through the third node N3. For example, the first electrode of the third transistor T3 may be a drain electrode, and the second electrode thereof may be a source electrode, but is not limited thereto.

The fourth transistor T4 may be turned on by the second gate signal GR of the second gate line GRL to electrically connect the reference voltage line VRL to the first node N1 that is the gate electrode of the first transistor T1. The fourth transistor T4 may be turned on based on the second gate signal GR to compensate the gate electrode of the first transistor T1 with a reference voltage Vref. The gate electrode of the fourth transistor T4 may be connected to the second gate line GRL, the first electrode thereof may be connected to the reference voltage line VRL, and the second electrode thereof may be connected to the first node N1. The second electrode of the fourth transistor T4 may be electrically connected to the gate electrode of the first transistor T1, to the first electrode of the third transistor T3, and to the first electrode of the first capacitor C1 through the first node N1. For example, the first electrode of the fourth transistor T4 may be a drain electrode and the second electrode thereof may be a source electrode, but is not limited thereto.

The fifth transistor T5 may be turned on by a first emission signal EM1 of the first emission control line EML1 to electrically connect the driving voltage line VDL with the first electrode of the first transistor T1. The gate electrode of the fifth transistor T5 may be connected to the first emission control line EML1, the first electrode thereof may be connected to the driving voltage line VDL, and the second electrode thereof may be connected to the first electrode of the first transistor T1. For example, the first electrode of the fifth transistor T5 may be a source electrode, and the second electrode thereof may be a drain electrode, but the present disclosure is not limited thereto.

The sixth transistor T6 may be turned on by the second emission signal EM2 of the second emission control line EML2 to electrically connect the second node N2 that is the second electrode of the first transistor T1 with the first electrode of the light-emitting element ED. The gate electrode of the sixth transistor T6 may be connected to the second emission control line EML2, the first electrode thereof may be connected to the second node N2, and the second electrode thereof may be connected to the first electrode of the light-emitting element ED. The first electrode of the sixth transistor T6 may be electrically connected to the second electrode of the first transistor T1, to the first electrode of the seventh transistor T7, to the second electrode of the first capacitor C1, and to the second electrode of the second capacitor C2 through the second node N2. For example, the first electrode of the sixth transistor T6 may be a source electrode, and the second electrode thereof may be a drain electrode, but the present disclosure is not limited thereto.

The seventh transistor T7 may be turned on by a third gate signal GB of the third gate line GBL to electrically connect the initialization voltage line VIL to the second node N2. The seventh transistor T7 may be turned on based on the third gate signal GB to initialize the second node N2 to an initialization voltage Vint. The gate electrode of the seventh transistor T7 may be connected to the third gate line GBL, the first electrode thereof may be connected to the second node N2, and the second electrode thereof may be connected to the initialization voltage line VIL. The first electrode of the seventh transistor T7 may be electrically connected to the second electrode of the first transistor T1, the first electrode of the sixth transistor T6, the second electrode of the first capacitor C1, and the second electrode of the second capacitor C2 through the second node N2. For example, the first electrode of the seventh transistor T7 may be a drain electrode, and the second electrode thereof may be a source electrode, but is not limited thereto.

The fifth transistor T5 and the sixth transistor T6 may include a silicon-based semiconductor region. For example, the fifth and sixth transistors T5 and T6 may include a semiconductor region made of low temperature polycrystalline silicon (LTPS). The semiconductor region made of low temperature polycrystalline silicon may have high electron mobility and excellent turn-on characteristics. Accordingly, the display device 10 includes the fifth and sixth transistors T5 and T6 having excellent turn-on characteristics, thereby stably and efficiently driving the plurality of pixels SP.

The fifth and sixth transistors T5 and T6 may correspond to p-type transistors. For example, the fifth and sixth transistors T5 and T6 may output a current flowing through the first electrode to the second electrode based on the gate low voltage applied to the gate electrode.

The first transistor T1, the second transistor T2, the third transistor T3, the fourth transistor T4, and the seventh transistor T7 may include an oxide-based semiconductor region. For example, the first to fourth and seventh transistors T1, T2, T3, T4, and T7 may have a coplanar structure in which the gate electrode is located on the oxide-based semiconductor region. The transistor having the coplanar structure may have excellent leakage current characteristics and perform low frequency driving, thereby reducing power consumption. Accordingly, the display device 10 may include the first to fourth and seventh transistors T1, T2, T3, T4, and T7 having excellent leakage current characteristics, thereby reducing or preventing a leakage current from flowing in the pixel, and stably maintaining the voltage in the pixel.

The first to fourth and seventh transistors T1, T2, T3, T4, and T7 may correspond to n-type transistors. For example, the first to fourth and seventh transistors T1, T2, T3, T4, and T7 may output a current flowing through the first electrode to the second electrode based on the gate high voltage applied to the gate electrode.

As another example, at least one of the second to seventh transistors T2, T3, T4, T5, T6, or T7 may be implemented as a transistor of a type different from the type shown in FIG. 4.

The first capacitor C1 may be connected between the first node N1, which is the gate electrode of the first transistor T1, and the second node N2, which is the source electrode of the first transistor T1. For example, the first electrode of the first capacitor C1 may be connected to the first node N1, and the second electrode of the first capacitor C1 may be connected to the second node N2, so that a potential difference between the first and second nodes N1 and N2 may be maintained.

The second capacitor C2 may be connected between the third node N3, which is the bias electrode of the first transistor T1, and the second node N2, which is the source electrode of the first transistor T1. For example, the first electrode of the second capacitor C2 may be connected to the third node N3, and the second electrode of the second capacitor C2 is connected to the second node N2, so that a potential difference between the third and second nodes N3 and N2 may be maintained.

Referring to FIG. 5 in conjunction with FIG. 4, the display device 10 may be driven at a corresponding driving frequency (e.g., predetermined driving frequency), and an input period of data may be determined according to the frequency. One frame period may include first to fourth periods t1 to t4.

The seventh transistor T7 may receive the third gate signal GB of a high level during a first period t1. The seventh transistor T7 may be turned on based on the high-level third gate signal GB, and may initialize the second node N2, which is the source electrode of the first transistor T1, to the initialization voltage Vint.

The sixth transistor T6 may receive the second emission signal EM2 of a low level during the first period t1. The sixth transistor T6 may be turned on based on the low-level second emission signal EM2, and may initialize the first electrode of the light-emitting element ED to the initialization voltage Vint.

The third and fourth transistors T3 and T4 may receive the second gate signal GR of a high level during a second period t2. The fourth transistor T4 may be turned on based on the high-level second gate signal GR to supply the reference voltage Vref to the first node N1 that is the gate electrode of the first transistor T1. The third transistor T3 may be turned on based on the high-level second gate signal GR, and may supply the reference voltage Vref to the third node N3, which is the bias electrode of the first transistor T1. Therefore, the third and fourth transistors T3 and T4 may compensate the first node N1, which is the gate electrode of the first transistor T1, and the third node N3, which is the bias electrode of the first transistor T1, with the reference voltage Vref during the second period t2.

Upon the completion of the compensation of the first and third nodes N1 and N3 and the initialization of the second node N2, a voltage across each of the first and second capacitors C1 and C2 may correspond to a difference voltage Vref-Vint between the reference voltage Vref and the initialization voltage Vint. Each of the first and second capacitors C1 and C2 may store the threshold voltage Vth of the first transistor T1.

The second transistor T2 may receive the first gate signal GW of a high level during a third period t3. The second transistor T2 may be turned on based on the high-level first gate signal GW, and may supply a data voltage Vdata to the third node N3 which is the bias electrode of the first transistor T1. When data writing is completed, a voltage across the second capacitor C2 may correspond to a difference voltage Vdata-Vint between a data voltage Vdata and the initialization voltage Vint, and the bias-source voltage of the first transistor T1 may become greater than the threshold voltage Vth (Vdata-Vint Cambria Math Vth), allowing the first transistor T1 to be turned on. Accordingly, the drain-source current of the first transistor T1 may be determined according to the data voltage Vdata, the initialization voltage Vint, and the threshold voltage Vth of the first transistor T1 (Ids=k×(Vdata−Vint−Vth)²). The first transistor T1 may supply the drain-source current to the second node N2 until the bias-source voltage reaches the threshold voltage Vth of the first transistor T1. In this manner, while the first transistor T1 is turned on, the voltage of the second node N2 and the drain-source current of the first transistor T1 may be changed, and the voltage of the second node N2 may eventually converge to a difference voltage Vdata-Vth between the data voltage Vdata and the threshold voltage Vth of the first transistor T1.

The display device 10 may include the first capacitor C1 to compensate for the voltage of the gate electrode of the first transistor T1 relatively quickly, and may include the second capacitor C2 to control the turn-on timing of the first transistor T1 and adjust the luminance of the pixel SP. The display device 10 includes the first capacitor C1 connected between the first and second nodes N1 and N2, and the second capacitor C2 connected between the third and second nodes N3 and N2, thereby improving or optimizing the number of transistors in the pixel circuit to reduce the area of the pixel circuit and improve the resolution of a product.

The first and second emission signals EM1 and EM2 may have a gate low voltage during a fourth period t4. When the first and second emission signals EM1 and EM2 have a low level, the fifth and sixth transistors T5 and T6 may be turned on to supply a driving current to the light-emitting element ED.

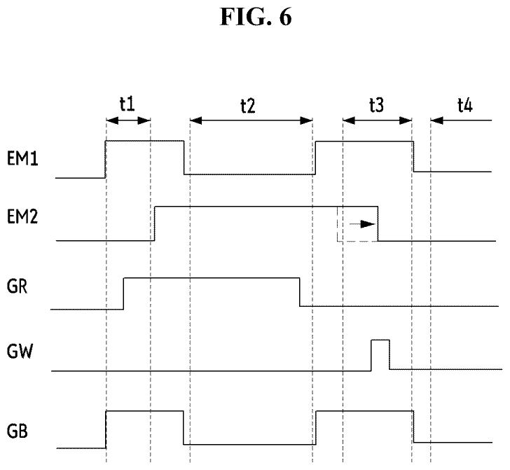

FIG. 6 illustrates another example of a waveform diagram of signals supplied to a pixel in a display device according to one or more embodiments. The waveform diagram of the signals in FIG. 6 is different from the waveform diagram of the signals in FIG. 5 with respect to the timing of the second emission signal EM2, and the same configurations as those described above will be briefly described, or repeated descriptions thereof will be omitted.

Referring to FIG. 6, the display device 10 may be driven at a corresponding driving frequency (e.g., predetermined driving frequency), and an input period of data may be determined according to the frequency. One frame period may include the first to fourth periods t1 to t4.

The first and second emission signals EM1 and EM2 may have a gate low voltage during the fourth period t4. When the first and second emission signals EM1 and EM2 have a low level, the fifth and sixth transistors T5 and T6 may be turned on to supply a driving current to the light-emitting element ED.

In FIG. 5, the second emission signal EM2 may have a low level before the first gate signal GW has a high level. In FIG. 6, the second emission signal EM2 may have a low level while the first gate signal GW has a high level, or after the first gate signal GW has a high level. Accordingly, the turn-on timing of the sixth transistor T6 of FIG. 6 may be later than the turn-on timing of the sixth transistor T6 of FIG. 5, and the display device 10 may adjust the light-emitting duty of the light-emitting element ED based on the pulse width of the second emission signal EM2 to adjust the image quality of the product.

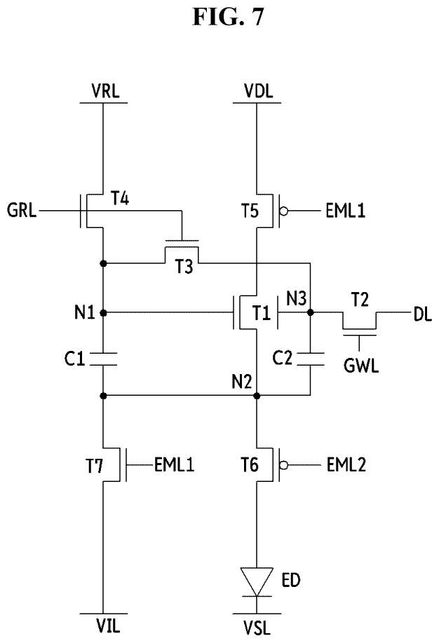

FIG. 7 is a circuit diagram showing a pixel of a display device according to one or more other embodiments. The pixel of FIG. 7 differs from the pixel of FIG. 4 in a line connected to the gate electrode of the seventh transistor T7, and the same configurations as those described above will be briefly described, or repeated descriptions thereof will be omitted.

Referring to FIG. 7, the pixel SP may be connected to the first gate line GWL, the second gate line GRL, the first emission control line EML1, the second emission control line EML2, the data line DL, the driving voltage line VDL, the reference voltage line VRL, the initialization voltage line VIL, and the low potential line VSL.

The seventh transistor T7 may be turned on by the first emission signal EM1 of the first emission control line EML1 to electrically connect the initialization voltage line VIL with the second node N2. The seventh transistor T7 may be turned on based on the first emission signal EM1 to initialize the second node N2 to the initialization voltage Vint. The gate electrode of the seventh transistor T7 may be connected to the first emission control line EML1, the first electrode thereof may be connected to the second node N2, and the second electrode thereof may be connected to the initialization voltage line VIL.

Accordingly, by omitting the third gate line GBL from the display device 10 of FIG. 4, the display device 10 of FIG. 7 may be capable of reducing the number of lines of the pixel circuit, thereby reducing the area of the pixel circuit.

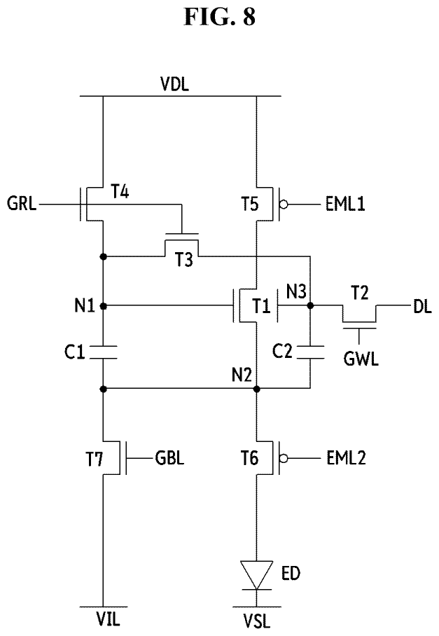

FIG. 8 is a circuit diagram showing a pixel of a display device according to yet one or more other embodiments. The pixel of FIG. 8 differs from the pixel of FIG. 4 in a line connected to the first electrode of the fourth transistor T4, and the same configurations as those described above will be briefly described, or repeated descriptions thereof will be omitted.

Referring to FIG. 8, the pixel SP may be connected to the first gate line GWL, the second gate line GRL, the third gate line GBL, the first emission control line EML1, the second emission control line EML2, the data line DL, the driving voltage line VDL, the initialization voltage line VIL, and the low potential line VSL.

The fourth transistor T4 may be turned on by the second gate signal GR of the second gate line GRL to electrically connect the driving voltage line VDL to the first node N1 that is the gate electrode of the first transistor T1. The fourth transistor T4 may be turned on based on the second gate signal GR to compensate the gate electrode of the first transistor T1 with a driving voltage. The gate electrode of the fourth transistor T4 may be connected to the second gate line GRL, the first electrode thereof may be connected to the driving voltage line VDL, and the second electrode thereof may be connected to the first node N1. Here, a driving voltage may be greater than a reference voltage.

Accordingly, by omitting the reference voltage line VRL from the display device 10 of FIG. 4, the display device 10 of FIG. 8 may be capable of reducing the number of lines of the pixel circuit, thereby reducing the area of the pixel circuit.

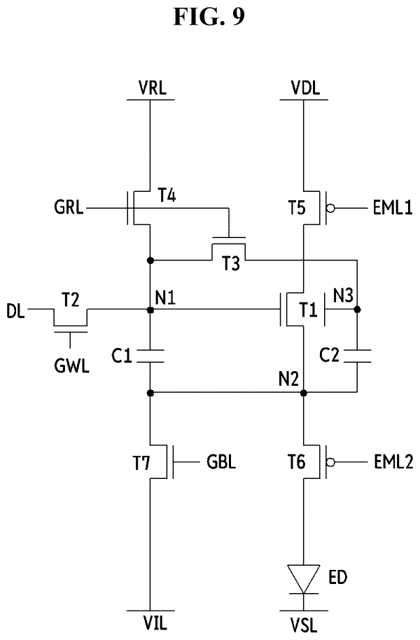

FIG. 9 is a circuit diagram showing a pixel of a display device according to yet one or more other embodiments. The display device of FIG. 9 is different from the display device of FIG. 4 with respect to the position of the second transistor T2, so that the same configurations as those described above will be briefly described, or repeated descriptions thereof will be omitted.

Referring to FIG. 9, the pixel SP may be connected to a first gate line GWL, a second gate line GRL, a third gate line GBL, a first emission control line EML1, a second emission control line EML2, the data line DL, a driving voltage line VDL, a reference voltage line VRL, an initialization voltage line VIL, and a low potential line VSL.

The pixel SP may include a light-emitting element ED and a pixel circuit for driving the light-emitting element ED. The pixel circuit may include the first to seventh transistors T1, T2, T3, T4, T5, T6, and T7 and the first and second capacitors C1 and C2.

The first transistor T1 may control a driving current supplied to the light-emitting element ED. The first transistor T1 may include a gate electrode, a first electrode, a second electrode, and a bias electrode. The gate electrode of the first transistor T1 may be connected to the first node N1, the first electrode thereof may be connected to the second electrode of the fifth transistor T5, the second electrode thereof may be connected to the second node N2, and the bias electrode thereof may be connected to the third node N3.

The first transistor T1 may control the drain-source current (hereinafter, referred to as “driving current”) based on a data voltage applied to the gate electrode. The first capacitor C1 may be connected between the gate electrode and the source electrode of the first transistor T1 to maintain a potential difference between the gate electrode and the source electrode of the first transistor T1. The second capacitor C2 may be connected between the bias electrode and the source electrode of the first transistor T1 to maintain a potential difference between the bias electrode and the source electrode of the first transistor T1. The driving current flowing through the channel of the first transistor T1 may be proportional to the square of a difference between the threshold voltage Vth and a voltage Vgs between the gate electrode and the source electrode of the first transistor T1 (Ids=k×(Vgs−Vth)²). Here, k is a proportional coefficient determined by the structure and physical characteristics of the first transistor T1, Vgs is a gate-source voltage of the first transistor T1, and Vth is a threshold voltage of the first transistor T1. The gate-source voltage Vgs of the first transistor T1 may correspond to a voltage across the first capacitor C1.

The second transistor T2 may be turned on by a first gate signal GW of the first gate line GWL to electrically connect the data line DL with the first node N1 that is the gate electrode of the first transistor T1. The second transistor T2 may be turned on based on the first gate signal GW to supply the data voltage to the first node N1. The gate electrode of the second transistor T2 may be connected to the first gate line GWL, the first electrode thereof may be connected to the data line DL, and the second electrode thereof may be connected to the first node N1. The second electrode of the second transistor T2 may be electrically connected to the gate electrode of the first transistor T1, to the first electrode of the third transistor T3, to the second electrode of the fourth transistor T4, and to the first electrode of the first capacitor C1 through the first node N1.

The third transistor T3 may be turned on by the second gate signal GR of the second gate line GRL to electrically connect the first node N1, which is the gate electrode of the first transistor T1, to the third node N3, which is the bias electrode of the first transistor T1. The gate electrode of the third transistor T3 may be connected to the second gate line GRL, the first electrode thereof may be connected to the first node N1, and the second electrode thereof may be connected to the third node N3. The first electrode of the third transistor T3 may be electrically connected to the gate electrode of the first transistor T1, to the second electrode of the second transistor T2, to the second electrode of the fourth transistor T4, and to the first electrode of the first capacitor C1 through the first node N1. The second electrode of the third transistor T3 may be electrically connected to the bias electrode of the first transistor T1 and to the first electrode of the second capacitor C2 through the third node N3.

The fourth transistor T4 may be turned on by the second gate signal GR of the second gate line GRL to electrically connect the reference voltage line VRL to the first node N1 that is the gate electrode of the first transistor T1. The fourth transistor T4 may be turned on based on the second gate signal GR to compensate the gate electrode of the first transistor T1 with the reference voltage Vref. The gate electrode of the fourth transistor T4 may be connected to the second gate line GRL, the first electrode thereof may be connected to the reference voltage line VRL, and the second electrode thereof may be connected to the first node N1. The second electrode of the fourth transistor T4 may be electrically connected to the gate electrode of the first transistor T1, to the second electrode of the second transistor T2, to the first electrode of the third transistor T3, and to the first electrode of the first capacitor C1 through the first node N1.

The fifth transistor T5 may be turned on by the first emission signal EM1 of the first emission control line EML1 to electrically connect the driving voltage line VDL with the first electrode of the first transistor T1. The gate electrode of the fifth transistor T5 may be connected to the first emission control line EML1, the first electrode thereof may be connected to the driving voltage line VDL, and the second electrode thereof may be connected to the first electrode of the first transistor T1.

The sixth transistor T6 may be turned on by the second emission signal EM2 of the second emission control line EML2 to electrically connect the second node N2, which is the second electrode of the first transistor T1, with the first electrode of the light-emitting element ED. The gate electrode of the sixth transistor T6 may be connected to the second emission control line EML2, the first electrode thereof may be connected to the second node N2, and the second electrode thereof may be connected to the first electrode of the light-emitting element ED. The first electrode of the sixth transistor T6 may be electrically connected to the second electrode of the first transistor T1, to the first electrode of the seventh transistor T7, to the second electrode of the first capacitor C1, and to the second electrode of the second capacitor C2 through the second node N2.

The seventh transistor T7 may be turned on by the third gate signal GB of the third gate line GBL to electrically connect the initialization voltage line VIL to the second node N2. The seventh transistor T7 may be turned on based on the third gate signal GB to initialize the second node N2 to the initialization voltage Vint. The gate electrode of the seventh transistor T7 may be connected to the third gate line GBL, the first electrode thereof may be connected to the second node N2, and the second electrode thereof may be connected to the initialization voltage line VIL. The first electrode of the seventh transistor T7 may be electrically connected to the second electrode of the first transistor T1, to the first electrode of the sixth transistor T6, to the second electrode of the first capacitor C1, and to the second electrode of the second capacitor C2 through the second node N2.

The first capacitor C1 may be connected between the first node N1, which is the gate electrode of the first transistor T1, and the second node N2, which is the source electrode of the first transistor T1. For example, the first electrode of the first capacitor C1 may be connected to the first node N1, and the second electrode of the first capacitor C1 may be connected to the second node N2, so that a potential difference between the first and second nodes N1 and N2 may be maintained.

The second capacitor C2 may be connected between the third node N3, which is the bias electrode of the first transistor T1, and the second node N2, which is the source electrode of the first transistor T1. For example, the first electrode of the second capacitor C2 may be connected to the third node N3, and the second electrode of the second capacitor C2 is connected to the second node N2, so that a potential difference between the third and second nodes N3 and N2 may be maintained.

Referring to FIG. 9 in conjunction with FIG. 5, upon the completion of the compensation of the first and third nodes N1 and N3 and the initialization of the second node N2, a voltage across each of the first and second capacitors C1 and C2 may correspond to a difference voltage Vref-Vint between the reference voltage Vref and the initialization voltage Vint. Each of the first and second capacitors C1 and C2 may store the threshold voltage Vth of the first transistor T1.

The second transistor T2 may receive the first gate signal GW of a high level during the third period t3. The second transistor T2 may be turned on based on the high-level first gate signal GW, and may supply the data voltage Vdata to the first node N1 which is the gate electrode of the first transistor T1. When data writing is completed, a voltage across the first capacitor C1 may correspond to a difference voltage Vdata-Vint between a data voltage Vdata and the initialization voltage Vint, and the gate-source voltage Vgs of the first transistor T1 may become greater than the threshold voltage Vth (Vdata-Vint≥Vth), allowing the first transistor T1 to be turned on. Accordingly, the drain-source current of the first transistor T1 may be determined according to the data voltage Vdata, the initialization voltage Vint, and the threshold voltage Vth of the first transistor T1 (Ids=k×(Vdata−Vint−Vth)²). The first transistor T1 may supply the drain-source current to the second node N2 until the gate-source voltage Vgs reaches the threshold voltage Vth of the first transistor T1. In this manner, while the first transistor T1 is turned on, the voltage of the second node N2 and the drain-source current of the first transistor T1 may be changed, and the voltage of the second node N2 may eventually converge to a difference voltage Vdata-Vth between the data voltage Vdata and the threshold voltage Vth of the first transistor T1.

The display device 10 may include the first capacitor C1 to control the turn-on timing of the first transistor T1, and to adjust the luminance of the pixel SP, and may include the second capacitor C2 to compensate for the voltage of the gate electrode of the first transistor T1 relatively quickly. The display device 10 includes the first capacitor C1 connected between the first and second nodes N1 and N2 and the second capacitor C2 connected between the third and second nodes N3 and N2, thereby improving or optimizing the number of transistors in the pixel circuit to reduce the area of the pixel circuit and improve the resolution of a product.

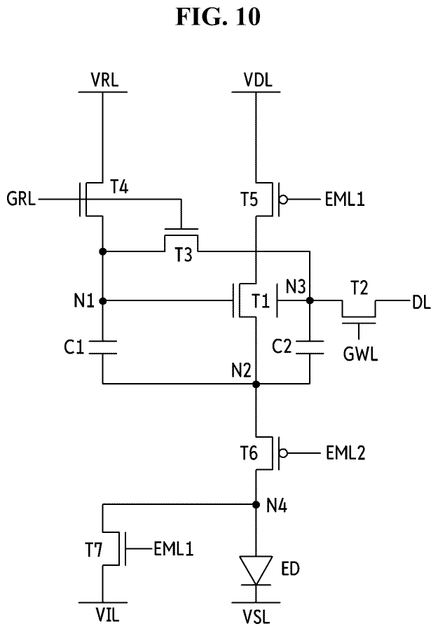

FIG. 10 is a circuit diagram showing a pixel of a display device according to yet one or more other embodiments. The display device of FIG. 10 is different from the display device of FIG. 4 with respect to the position of the seventh transistor T7, so that the same configurations as those described above will be briefly described, or repeated descriptions thereof will be omitted.

Referring to FIG. 10, the pixel SP may be connected to a first gate line GWL, a second gate line GRL, a third gate line GBL, a first emission control line EML1, a second emission control line EML2, the data line DL, a driving voltage line VDL, a reference voltage line VRL, an initialization voltage line VIL, and a low potential line VSL.

The seventh transistor T7 may be turned on by the first emission signal EM1 of the first emission control line EML1 to electrically connect the initialization voltage line VIL to the fourth node N4, which is the first electrode of the light-emitting element ED. The seventh transistor T7 may be turned on based on the first emission signal EM1 to initialize the fourth node N4 to the initialization voltage Vint. The gate electrode of the seventh transistor T7 may be connected to the first emission control line EML1, the first electrode thereof may be connected to the fourth node N4, and the second electrode thereof may be connected to the initialization voltage line VIL.

The display device according to one or more embodiments of the present disclosure can be applied to various electronic devices. The electronic device according to the one or more embodiments of the present disclosure includes the display device described above, and may further include modules or devices having additional functions in addition to the display device.

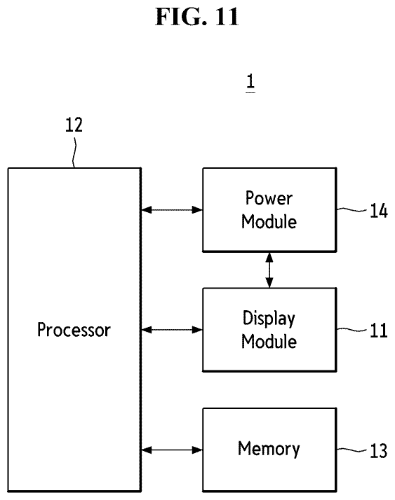

FIG. 11 is a block diagram of an electronic device according to one or more embodiments of the present disclosure.

Referring to FIG. 11, the electronic device 1 according to one or more embodiments of the present disclosure may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 15 may store data information suitable for the operation of the processor 12 or the display module 11. When the processor 12 executes an application stored in the memory 15, an image data signal and/or an input control signal is transmitted to the display module 11, and the display module 11 can process the received signal and output image information through a display screen.

The power module 14 may include a power supply module such as, for example a power adapter or a battery, and a power conversion module that converts the power supplied by the power supply module to generate power suitable for the operation of the electronic device 1.

At least one of the components of the electronic device 1 according to the one or more embodiments of the present disclosure may be included in the display device 10 according to the embodiments of the present disclosure. In addition, some modules of the individual modules functionally included in one module may be included in the display device 10, and other modules may be provided separately from the display device 10. For example, the display device 10 may include the display module 11, and the processor 12, the memory 13, and the power module 14 may be provided in the form of other devices within the electronic device 1 other than the display device 10.

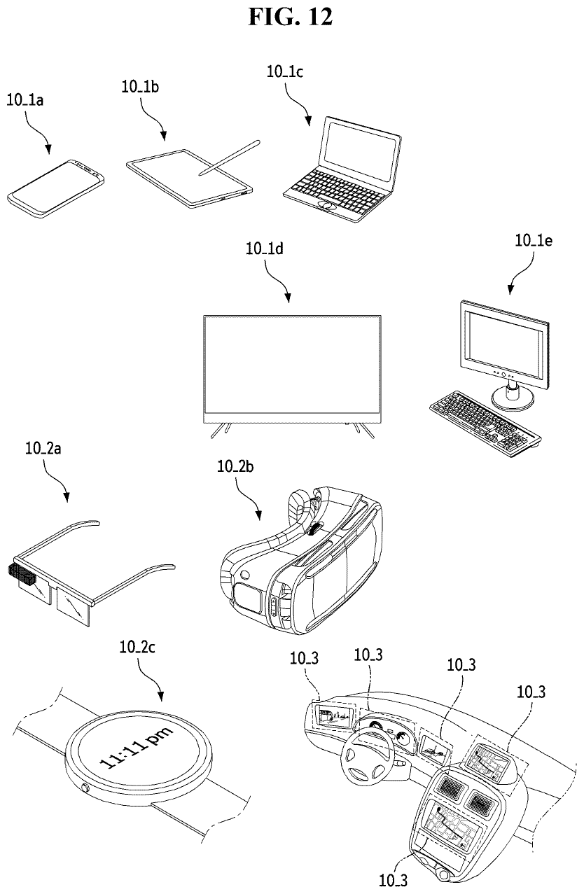

FIG. 12 is a schematic diagram of an electronic device according to various embodiments of the present disclosure.

Referring to FIG. 12, various electronic devices to which display devices 10 according to embodiments of the present disclosure are applied may include not only image display electronic devices, such as a smart phone 10_1a, a tablet PC (personal computer) 10_1b, a laptop 10_1c, a TV 10_1d, and a desk monitor 10_1e, but also wearable electronic devices including display modules such as, for example smart glasses 10_2a, a head mounted display 10_2b, and a smart watch 10_2c, and vehicle electronic devices 10_3 including display modules, such as a CID (Center Information Display) and a room mirror display arranged on a dashboard, center fascia, and dashboard of an automobile.

Although the embodiments of the present disclosure have been described with reference to the attached drawings, those skilled in the art will understand that the present disclosure can be implemented in other specific forms without changing the technical idea or essential features of the present disclosure. Therefore, it should be understood that the embodiments described above are example in all respects and not restrictive.

What is claimed is:

1. A display device comprising:
a light-emitting element configured to emit light;
a first transistor configured to control a driving current through the light-emitting element;
a second transistor configured to supply a data voltage to a bias electrode of the first transistor based on a first gate signal;
a first capacitor between a gate electrode of the first transistor and a source electrode of the first transistor; and
a second capacitor between the bias electrode of the first transistor and the source electrode of the first transistor.

2. The display device of claim 1, further comprising:
a third transistor configured to electrically connect the gate electrode and the bias electrode of the first transistor; and
a fourth transistor configured to supply a reference voltage to the gate electrode of the first transistor.

3. The display device of claim 1, further comprising:
a third transistor configured to electrically connect the gate electrode and the bias electrode of the first transistor;
a fourth transistor configured to supply a driving voltage to the gate electrode of the first transistor; and
a fifth transistor configured to supply the driving voltage to a drain electrode of the first transistor.

4. The display device of claim 2, further comprising:
a fifth transistor configured to supply a driving voltage to the drain electrode of the first transistor; and
a sixth transistor configured to electrically connect the source electrode of the first transistor and a first electrode of the light-emitting element.

5. The display device of claim 4, further comprising a seventh transistor configured to initialize the source electrode of the first transistor to an initialization voltage.

6. The display device of claim 5, wherein the first, second, third, fourth, and seventh transistors comprise n-type transistors, and
wherein the fifth and sixth transistors comprise p-type transistors.

7. The display device of claim 5, wherein the seventh transistor is configured to be turned on based on a third gate signal during a first period,
wherein the third and fourth transistors are configured to be turned on based on a second gate signal during a second period after the first period, and
wherein the second transistor is configured to be turned on based on the first gate signal during a third period after the second period.

8. The display device of claim 7, wherein the sixth transistor is configured to be turned on based on a second emission signal during the first period, during the third period, and during a fourth period after the third period, and
wherein the fifth transistor is configured to be turned on based on a first emission signal during the second period and during the fourth period.

9. The display device of claim 7, wherein the sixth transistor is configured to be turned on before the second transistor is turned on during the third period.

10. The display device of claim 7, wherein the sixth transistor is configured to be turned on while the second transistor is turned on, or after the second transistor is turned on.

11. The display device of claim 5, wherein a gate electrode of the seventh transistor and a gate electrode of the fifth transistor are connected to a first emission control line to which a first emission signal is applied.

12. The display device of claim 4, further comprising a seventh transistor configured to initialize the first electrode of the light-emitting element to an initialization voltage.

13. A display device comprising:
a light-emitting element configured to emit light;
a first transistor configured to control a driving current flowing through the light-emitting element;
a second transistor configured to supply a data voltage to a gate electrode of the first transistor based on a first gate signal;
a third transistor configured to electrically connect a bias electrode and the gate electrode of the first transistor;
a first capacitor between the gate electrode of the first transistor and a source electrode of the first transistor; and
a second capacitor between the bias electrode of the first transistor and the source electrode of the first transistor.

14. The display device of claim 13, further comprising a fourth transistor configured to supply a reference voltage to the gate electrode of the first transistor.

15. The display device of claim 14, further comprising:
a fifth transistor configured to supply a driving voltage to a drain electrode of the first transistor; and
a sixth transistor configured to electrically connect the source electrode of the first transistor and a first electrode of the light-emitting element.

16. The display device of claim 15, further comprising a seventh transistor configured to initialize the source electrode of the first transistor to an initialization voltage.

17. The display device of claim 16, wherein the seventh transistor is configured to be turned on based on a third gate signal during a first period,
wherein the third and fourth transistors are configured to be turned on based on a second gate signal during a second period after the first period, and
wherein the second transistor is configured to be turned on based on the first gate signal during a third period after the second period.

18. The display device of claim 17, wherein the sixth transistor is configured to be turned on based on a second emission signal during the first period, during the third period, and during a fourth period after the third period, and
wherein the fifth transistor is configured to be turned on based on a first emission signal during the second period and during the fourth period.

19. An electronic device comprising:
a display device configured to provide an image; and
a processor configured to provide an image data signal to the display device,
wherein the display device comprises:
a light-emitting element configured to emit light;
a first transistor configured to control a driving current flowing through the light-emitting element;
a second transistor configured to supply a data voltage to a bias electrode of the first transistor based on a first gate signal;
a seventh transistor configured to initialize a first electrode of the light-emitting element or a source electrode of the first transistor to an initialization voltage;
a first capacitor between a gate electrode of the first transistor and the source electrode of the first transistor; and
a second capacitor between the bias electrode of the first transistor and the source electrode of the first transistor.

20. The electronic device of claim 19, further comprising:
a third transistor configured to electrically connect the gate electrode and the bias electrode of the first transistor; and
a fourth transistor configured to supply a reference voltage to the gate electrode of the first transistor.
